(19) United States
(12) Patent Application Publication
(10) Pub. No.: US 2005/0216315 A1
(43) Pub. Date: Sep. 29, 2005

(54) Loan advancing system

(76) Inventor: James Andersson, Thorton, PA (US)

Correspondence Address: Alexander J. Burke;Intellectual Property Department, 5th Floor, 170 Wood Avenue South, Iselin, NJ, 08830, US

(21) Appl. No.: 10/945,284

(22) Filed: Sep. 20, 2004

Related U.S. Application Data
(60) Provisional application No. 60/557,353, filed on Mar. 29, 2004.

(51) Int. Cl. G06F 17/60

(52) U.S. Cl. 705/4

(57) ABSTRACT

A system advances loans secured by healthcare claims based on clinical and financial information associated with the claims. A loan advance system employs healthcare claim information related to provision of healthcare to patients. The system includes a data acquisition processor for acquiring clinically related information associated with a healthcare claim of a patient. A loan advance processor determines a portion of the claim total amount to be advanced as a loan to a healthcare provider organization, in response to the clinically related information associated with the claim and prior to evaluation of the claim by a claim payor organization.

This is a non-provisional application of provisional application Ser. No. 60/557,353 by J. Andersson filed Mar. 29, 2004.

### FIELD OF THE INVENTION

This invention concerns a loan advance system employing healthcare claim information related to provision of healthcare to patients.

### BACKGROUND INFORMATION

Factoring and Invoice Discounting services are currently available. However, these services typically involve manual processing which makes these services expensive and difficult to use. Factoring is common among firms that use their growing account receivables as collateral to buy components, resources and raw materials to expand production and continue growth. Existing factoring and Invoice Discounting services require a significant amount of manual intervention. Invoices or claims typically need to be manually reviewed, totaled and processed, for example. Further, existing systems may involve manual selection of appropriate items for processing. This is burdensome and often impractical in a large scale environment where thousands of invoices or claims need to be processed.

One known pharmacy system presented in U.S. Pat. No. 5,704,044 describes a system for advancing loan funds secured by already adjudicated prescription claims. The system advances loans based on limited criteria. Specifically, the evaluation of payor and obligor creditworthiness. Since the pharmacy claims have already been evaluated and become legal obligations to be paid by a responsible party, the system evaluates creditworthiness of the responsible parties as this is the remaining risk in securitizing these obligations. The system fails to accommodate the complexities of modern healthcare systems and fails to provide a flexible financing system capable of advancing loans for different types of invoices or claims and at different stages of the invoice or claim processing cycle. The described system also is limited in the criteria it evaluates in determining whether to advance a loan. A system according to invention principles addresses these deficiencies and associated problems.

### SUMMARY OF THE INVENTION

A system is seamlessly integrated with clinical information and healthcare financial claim processing applications to provide an integrated service for advancing loans secured by unadjudicated healthcare claims. A loan advance system employs healthcare claim information related to provision of healthcare to patients. The system includes a data acquisition processor for acquiring clinically related information associated with a healthcare claim of a patient. A loan advance processor determines a portion of the claim total amount to be advanced as a loan to a healthcare provider organization, in response to the clinically related information associated with the claim and prior to evaluation of the claim by a claim payor organization.

### BRIEF DESCRIPTION OF THE DRAWING

FIG. 1 shows a loan advance system integrated with a clinical information and healthcare financial claim processing system, according to invention principles.

FIG. 2 shows functions of a financial processing and loan advance system, according to invention principles.

FIG. 3 shows a healthcare financial claim processing system operating in conjunction with a loan advance system, according to invention principles.

FIG. 4 shows function elements and operation of a loan advance system, according to invention principles.

FIG. 5 shows a flowchart of a process employed by a loan advance system, according to invention principles.

### DETAILED DESCRIPTION OF INVENTION

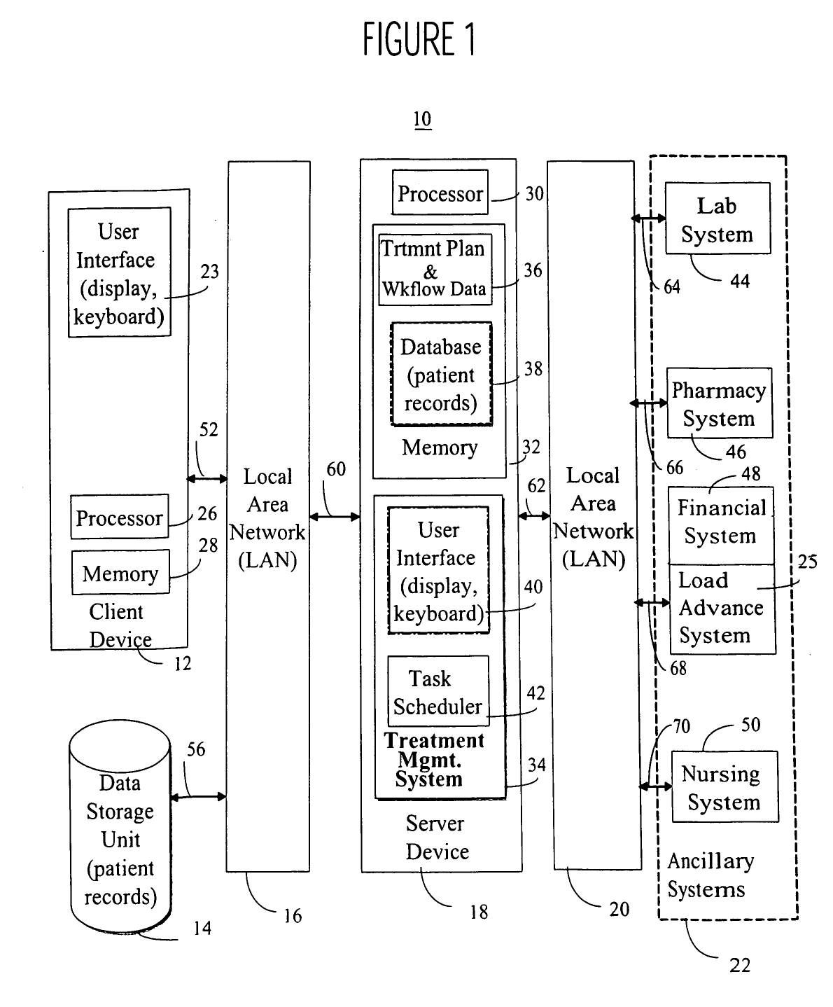

FIG. 1 shows a loan advance system 25 integrated with clinical information and healthcare financial claim processing applications. System 25 provides a service that is seamlessly integrated with clinical and financial claim processing operations of a Hospital Information System (HIS) for advancing loans secured by unadjudicated healthcare claims, that is claims that have not yet been declared valid and matured into legal obligations for payment by a payor organization. System 25 provides a hospital with additional flexibility in management of cash flow fluctuating due to seasonal variation in revenue and expenditure or late payments from insurers, for example. Existing systems are unable to manually manage a high volume of generated healthcare claims or invoices and process them to enable an existing factoring service to be able to advance loans secured by the claims. In contrast, system 25 advantageously processes healthcare claim information providing a Hospital with a convenient and inexpensive way of adjusting cash flow to better match requirements. Loan advance system 25 makes a direct loan payment to a recipient organization based on a claim that has been issued that same day or issued during a user predetermined time period. A loan recipient organization such as a healthcare provider, may be provided with rapid access (even substantially immediate access) to the loaned sum associated with a claim avoiding a 60 to 90 day credit analysis and evaluation delay period, for example.

It is desirable in healthcare Financial processing for a healthcare provider organization to obtain payment for services rendered as soon as possible. Healthcare providers may struggle under the burden of an average accounts receivable (AR) balance of about 70 days. This AR balance combined with, shrinking payments for services and payroll expenses can create cash flow problems for hospitals. System 25 provides same day payment for healthcare provider organizations based on claim information gathered by the clinical and financial information processing system of FIG. 1 and a substantial benefit to the healthcare provider. Known systems for obtaining loan advances include factoring and invoice discounting. Factoring is a term applied to the practice of selling accounts receivable to a third party. Companies use factoring to improve cash flow. Factoring is also known as Receivables financing, Sales Ledger financing, or Invoice Discounting. Invoice Discounting is distinguished from Factoring, because in Invoice Discounting the originating business retains control and responsibility for debt collection and bad debt. Factoring, Receivables financing, Sales Ledger financing, and Invoice Discounting involve loan advances secured by receivable interests already determined to be valid or matured into legal obligations for payment by a responsible party. In contrast, the loan advance system of FIG. 1 advances loans secured by immature receivables such as unadjudicated healthcare claims that have not yet been declared valid and matured into legal obligations for payment by a responsible party.

In one embodiment, system 25 electronically automatically sorts and selects claims and applies predetermined rules to an individual claim as it is processed and deposits a proportion of the claim as a loan to a recipient organization in response to recipient organization requirements and business rules. Loan funds are electronically transferred from a system operator to an intermediary account and thence to an owner of the claim (or owner of a portion of the claim). Loan funds advanced are computed as a proportion of a total claim value and the system operator receives a percentage of the associated loaned amount as a fee.

As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display generator or processor or user interface is a known element comprising electronic circuitry or software or a combination of both for generating display images or portions thereof. A record as used herein is a compilation of data in electronic form including a file, document, or other memorialization of data, event, occurrence or information. Further, a claim is an instrument used by payor organizations (including insurance companies and other reimbursement organizations) to recognize services and related changes but it does not create an absolute expectation of payment. In contrast, a bill (typically directed to a payor organization (as guarantor or other fiscally responsible party) is an expectation of payment.

FIG. 1 illustrates a healthcare information system 10 including a client device 12, a data storage unit 14, a first local area network (LAN) 16, a server device 18, a second local area network (LAN) 20, and ancillary systems 22. Systems 22 include Financial information system 48 for processing healthcare claims and for billing payors. Clinical and administrative applications of system 10 as well as financial application 48, comprising a Hospital Information System, seamlessly operate in conjunction with loan advance system 25 to provide an integrated service for advancing loans secured by unadjudicated healthcare claims. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

Client device 12 generally includes processor 26, memory unit 28 and user interface 23 and may comprise a personal computer or other processing device, for example. User interface 23 in the client device 12 generally includes an input device that permits a user to input information into the client device 12 and an output device that permits a user to receive information from the client device 12. Preferably, the input device is a keyboard and mouse, but also may be a touch screen or a microphone with a voice recognition program, for example. The output device is a display, but also may be a speaker, for example.

The data storage unit 14 stores patient records, as well as other information for the healthcare information system 10. Data storage unit 14 is separate from the client device 12 to permit multiple users to have access to patient records from multiple client devices and may be implemented as read only memory (ROM), such as on a compact disk (CD) or on a hard drive, or a random access memory (RAM), and the like, as is well know to those skilled in the art of data storage units. Alternatively, patient records may be stored in database 38 in memory unit 32 within server device 18, in memory unit 28 in client device 12, or in memory units in ancillary systems 22. Patient records in data storage unit 14 generally include information related to a patient including, without limitation, biographical, financial, clinical, workflow, and care plan information. The patient records may be represented in a variety of file formats including, without limitation, text files such as documents, graphic files such as a graphical trace including, for example, an electrocardiogram (ECG) trace, and an electro-encephalogram (EEG) trace, video files such as a still video image or a video image sequence, an audio file such as an audio sound or an audio segment, and visual files, such as a diagnostic image including, for example, a magnetic resonance image (MRI), an x-ray, a positron emission tomography (PET) scan, or a sonogram. The patient record is an organized collection of clinical information concerning one patient's relationship to a healthcare enterprise (e.g. region, hospital, clinic, or department). The patient record can narrowly be considered as a file cabinet or repository with divisions and indexing mechanisms. These divisions resemble a hierarchy with folders, documents and document components, or other objects representing collections of clinical elementary information. Such folder divisions include traditional classifications such as summaries, notes, investigations, orders, medications, correspondence, results, etc. An individual information element and object resides in a home location in this structure. Revision history is captured from within this home location.

The first local area network (LAN) 16 provides a communication network among the client device 12, the data storage unit 14 and the server device 18. The second local area network (LAN) 20 provides a communication network between the server device 18 and the ancillary systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol. The I.P. data format, otherwise called an I.P. protocol, uses IP addresses. Examples of the I.P. addresses include, without limitation, Transmission Control Protocol Internet Protocol (TCPIP) address, an I.P. address, a Universal Resource Locator (URL), and an electronic mail (Email) address. The communication paths 52, 56, 60, 62, 64, 66, 68 and 70 each may be formed as a wired or wireless (W/WL) connection.

The server device 18 provides clinical information system functions and includes a processor 30, a memory unit 32, and patient treatment monitoring system 34. The memory unit 32 includes workflow data and a treatment plan 36 and a database 38 containing patient records. Patient treatment monitoring system 34 includes a user interface 40 and Rules Engine and Workflow Engine (task scheduler) 42. Server device 18 may be implemented as a personal computer or a workstation. As previously mentioned, database 38 provides an alternate location for storing patient records, and user interface 40 is an alternate interface for a user. In the preferred embodiment of the present invention, patient treatment monitoring system 34 is responsive to user interface 23 in client device 12.

Ancillary systems 22 comprise clinical information systems including laboratory system 44, pharmacy system 46 and nursing system 50 and administrative systems including financial system 48 and loan advance system 25. Ancillary systems 22 may also include a records system, a radiology system, an accounting system, a billing system, and any other system required or desired in a healthcare information system. Loan advance system 25 operates in conjunction with financial processing system 48 used in processing healthcare claims and the clinical information systems.

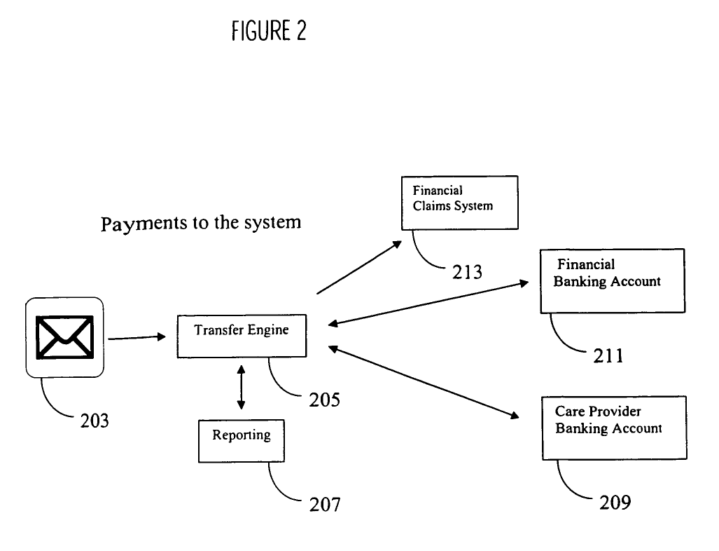

FIG. 2 shows functions of a financial processing and loan advance system embodied in units 48 and 25 of FIG. 1. Transfer engine 205 receives healthcare claim and clinical information 203 for particular patients and processes the received information to determine a sum to advance as a loan to a healthcare provider organization secured by unadjudicated healthcare claims that are to be processed, adjudicated and ultimately paid, at least in part, by a payor organization. Transfer engine 205 determines a sum to advance to a healthcare provider organization based on predetermined rules and criteria and also communicates claim information to financial claims system 213. Claims are generated by financial claim system 213 and forwarded to a clearing House or other processes for transmission to a payor organization. Reporting function 207 operates in conjunction with transfer engine 205 and totals and records selected claim sums. Transfer engine 205 moves funds directly from the loan advance system financial account 211 to a healthcare provider organization account 209 in response to the sum determined to be advanced by transfer engine 205. Further, in response to payments being received into account 211 (from a healthcare payor organization) that are associated with claims for which a loan has been advanced, appropriate fund sums are disbursed into account 209. Transfer engine 205 maintains accounts for individual healthcare claims and balances received payments from payor organizations against loan sums already advanced to a healthcare provider organizations secured by the individual claims. On a daily (or other user selected time period) basis, transfer engine 205 automatically pays a portion of selected claims that are generated and monitors receipt of funds from a payor organization for these selected claims. For example if claims for a day equal $100, transfer engine 205 deposits $70 in healthcare provider organization account 209. When after 60 days, $80 is collected and paid into loan advance system financial account 211, transfer engine 205 pays the $10 balance (less agreed fees) to account 209.

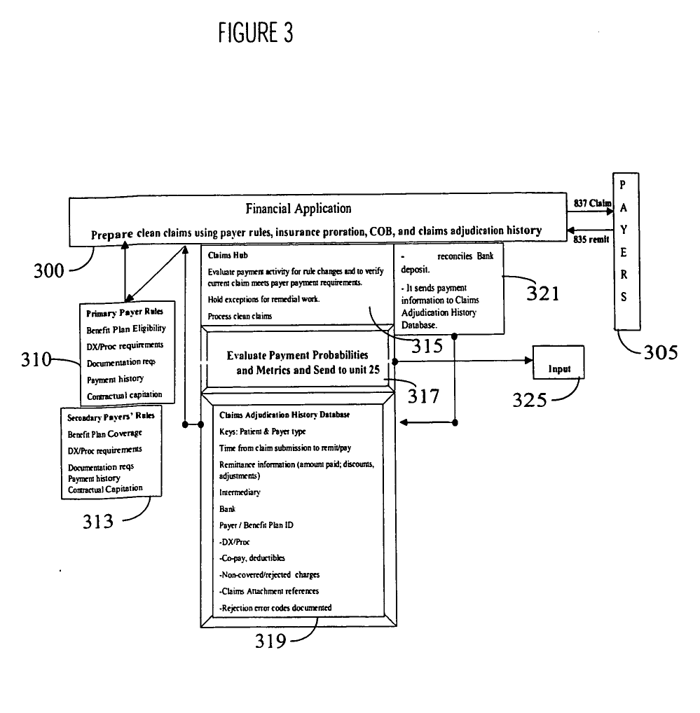

FIG. 3 shows healthcare financial claim processing system 48 (FIG. 1) operating in conjunction with loan advance system 25. Financial application 300 of unit 48 employs primary and secondary payor rules 310 and 313 respectively, to prepare healthcare claims (e.g. in ANSI X-12 837 transaction compatible format) for communication to a payor 305. Financial application 300 receives, in response, healthcare payment information (e.g. in ANSI X-12 835 transaction compatible format) identifying results of healthcare claim adjudication and payments made, from payor 305. Application 300 prepares healthcare claims based on primary and secondary payor rules 310 and 311 and applies payor rules throughout claim preparation to minimize claim rejections by a payor. Secondary payor insurance coverage is invoked when primary payor insurance coverage is exhausted. Payor rules 310 and 313 are used to determine whether a patient is eligible for reimbursement under a benefit plan, payor procedural requirements, documentation requirements, contractual terms and payment history. Further, payor rules 310 and 313 are adaptively updated to be consistent with claim adjudication history derived from database 319. Database 319 contains information associated with already adjudicated, processed and paid claims that have no outstanding transactions requiring completion. Further, database 319 is indexed by patient and payor type keys and contains data fields identifying documented rejection error codes, claim attachments, non-covered rejected charges, co-payments, deductibles, claim submission procedure, payor benefit plan identifier, bank, intermediary financial institution, remittance information (amount paid, discounts and adjustments) and time from claim submission to payment, for example.

Healthcare claims hub 315 of application 300 examines database 319 and determines if the healthcare claim and associated payment history indicates payor rules have changed and updates rules 310 and 313 in response to a determination payor rules have changed. Hub 315 also analyzes a prepared healthcare claim to determine if the claim is valid and meets current payor requirements and initiates processing of a validated claim. Unit 317 of application 300 estimates probability of payment of individual healthcare claims based on predetermined criteria and derived metrics and provides this information (325) to loan advance system 25. Unit 321 of application 300 reconciles and balances payments made by a payor 305 against corresponding submitted healthcare claimed sums and updates claim adjudication history database 319 with the payment information. Claims hub 315 supplies exact invoice information, actuarial information collected concerning received claim payment amounts and timing of payments collated by payor organization 305, for use by loan advance system 25. In another embodiment hub 315 may also segment claims for loan advance by payer organization (e.g. a loan advance is to be made on Medicaid claims).

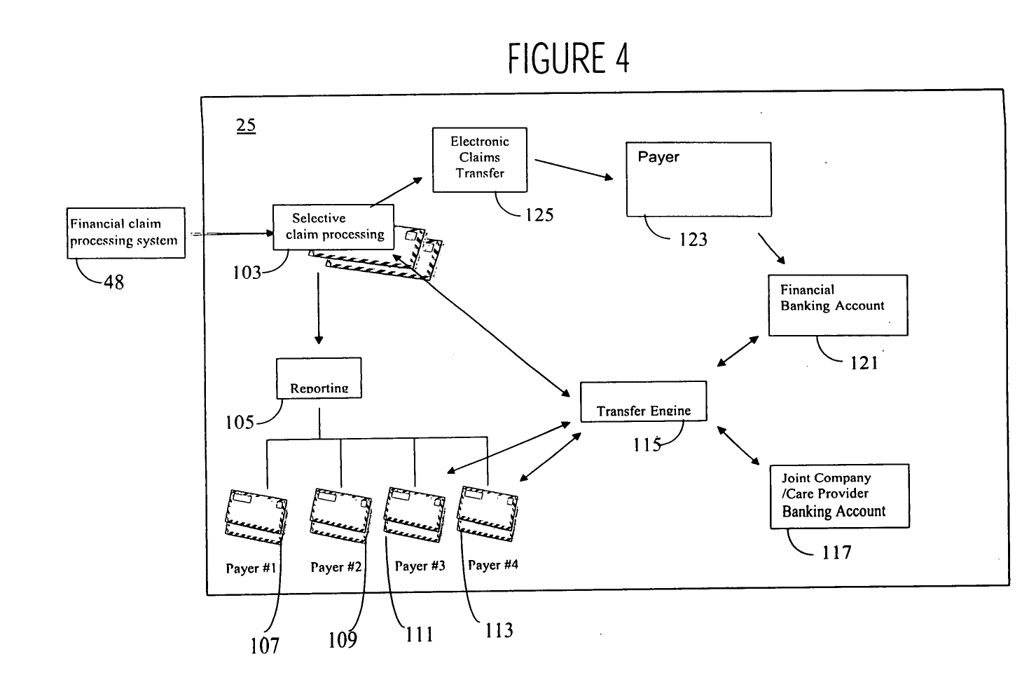

FIG. 4 shows function elements and operation of loan advance system 25 and financial processing system 48 of FIG. 1. Selection, routing and user interface unit 103 (FIG. 4) of loan advance system 25 receives healthcare claim and clinical information from unit 48 for particular patients. System 25 processes the received information to determine a sum to advance as a loan to a healthcare provider organization secured by unadjudicated healthcare claims. Selection unit 103 is integrated with financial claims processing system 48 to support automated payment and expedite healthcare claim reimbursements, either for a total number of claims produced during a predetermined time period, or for claims selected based on predetermined criteria or in particular categories. Unit 103 of loan advance system 25 provides a user interface (such as via unit 23 of FIG. 1) enabling selection of claims (e.g., based on a time a claim is produced, claim category or other selection criteria) for which a loan advance is to be made. This allows a financial officer of a user healthcare provider organization to arrange loan advances that meet the specific financial needs of a particular user healthcare provider organization, for example. Thereby a user is able to determine that immediate loan payment is advanced on Medicare healthcare claims over $500, for example.

Transfer engine 115 determines a sum to advance to a healthcare provider organization secured by claims selected by selection unit 103 based on predetermined rules and criteria. Specifically, transfer engine 115 employs intelligent analysis together with data accessed from claim adjudication history database 319 (FIG. 3), to evaluate healthcare claims pre-adjudication and post adjudication, as required. Adjudication is the process employed by a healthcare payor organization to determine whether a healthcare claim is to be paid and if so, in what amount based on the payor's own claim rules. Transfer engine 115 predicts a probability of receiving a particular payment amount and time of receiving the payment amount from a particular payor for a particular selected healthcare claim, portion of claim, group of claims or other selected claim categories. This prediction enables an operator of a loan advance service using system 25 to lend an agreed upon percentage of healthcare claim amount to a healthcare provider organization, either prior or post claim submission or at the time the claim is submitted, for a fee. Engine 115, in addition to determining an actuarial prediction, continuously maintains and updates records of payment activity. This information and continuous calculation of probability of payment time and amount by engine 115 improves prediction of claim payments thereby improving loan advance accuracy and operation and minimizing risk of loan default.

Transfer engine 115 continuously evaluates claims, to be submitted for payment (i.e. pre-adjudication), against the historical adjudicated claim and remittance information in database 319 (FIG. 3). This is done as part of the claim payment predictive analysis and involves determination of whether a claim conforms to payor specific reimbursement rules, provider and payor specific contractual rules, changes in payor rules automatically determined from submitted claims, errors, and rejected claims as well as seasonally adjusted changes in claim payment time. Transfer engine 115 calculates actuarial predictive payment information by payor, financial class and healthcare provider. This involves continuous calculation of claim submission success rate for an individual payor determined based on payment of claimed amount in full without claim rejection, objection or delay resulting from a request for supplementary information or correction due to error. Engine 115 also determines an expected payment proportion of a full claimed amount for the individual payor. The determined success rate and expected payment proportion are used to predict payment amounts and time to payment for claims by type of claim, payer, and other user-defined criteria.

Engine 115 advantageously uses claim associated information that is derived from financial application 48 and clinical information applications (shown in FIG. 1) including information such as codes indicating diagnoses, procedures, and therapies. This information is derived from a claim and processed by engine 115 with payor rules and customized healthcare provider specific and claim type specific rules. Loan advance system 25 employs the derived claim information to predict likelihood of payment and payment amount and advantageously enables determination of whether (and in what amount) a loan advance is to be made secured by a healthcare claim, prior to adjudication of the claim by a payor organization. These features substantially improve flexibility and scope of loan advance system 25 and use of the system by a healthcare provider, for example, in managing healthcare provider organization financial resources.

Selected claims that are deemed to be sufficiently creditworthy to secure a loan in response to a claim payment predictive analysis (and predetermined acceptance criteria), are processed by loan advance system 25 concurrently with being sent via electronic claims transfer system 125 to payer organization 123 for adjudication and payment. Loan advance system 25 monitors and records the time elapsing between submission of a healthcare claim to a payor organization 123 and payment (or communication of a rejection or error statement) by the payor organization. A user interface of unit 105 (e.g., user interface 23 of FIG. 1) displays the status of claims reimbursement using graphical reports and analytic information over user selected periods, such as daily, weekly, monthly, quarterly etc. Exception events and activities such as claims deemed to incomplete, in error, incompatible with payor adjudication requirements and rules or otherwise raise questions concerning likelihood of reimbursement and related activities are logged and analyzed by transfer engine 115 using claims adjudication history database 319 (FIG. 3). Authorized users at a healthcare provider location are able to override or adjust input to transfer engine 115 payment prediction calculations and initiate re-calculation of claim prediction analysis including determination of probability and time of payment. Such an override action triggers transfer engine 115 to generate a warning message for communication to a user and to record data in database 319 identifying an audit trail indicating source, user and other characteristics associated with an override action.

Transfer engine 115 moves funds directly from a bank account of a loan advance system 25 operator to joint account 117 of both a loan advance system operator and a healthcare provider organization in response to determination of a sum to be advanced and acceptance by the healthcare provider organization. Further, in response to payments being received into account 121 (from healthcare payor organization 123) that are associated with claims for which a loan has been advanced, transfer engine 115 balances received payments from payor organization 123 against loan sums already advanced to a healthcare provider organization secured by individual claims.

Unit 103 of loan advance system 25 further provides access to information such as via report generation or user interface display detailing claim amounts outstanding, cash-flow status and historical data and trends of a user healthcare provider organization. Unit 105 details outstanding claim amounts, loans advanced, cash flow characteristics and other data organized by individual payor organization such as by an individual payor of payors 107, 109, 111 and 113. The system also advantageously provides additional reporting and analysis functions. The system analyzes stored information and provides the analyzed information to users on request. Thereby a user is able to evaluate differing uses of loan advance system 25. A user is able to examine, for example, a projected cash position if either, all, or selected receivables were advanced. For instance, a user is able to determine a projected cash position if all Medicare receivables are advanced, if only receivables due from a particular organization (such as Blue Cross) are advanced, or if Medicare claims under $500 (or over $5000) dollars are advanced. Similarly, a user is able to determine a projected cash position if emergency room receivables are advanced, or outpatient or surgery receivables are advanced, or receivables associated with a particular time period (such as December receivables) are advanced. This advantageously allows a user to refine a cash position.

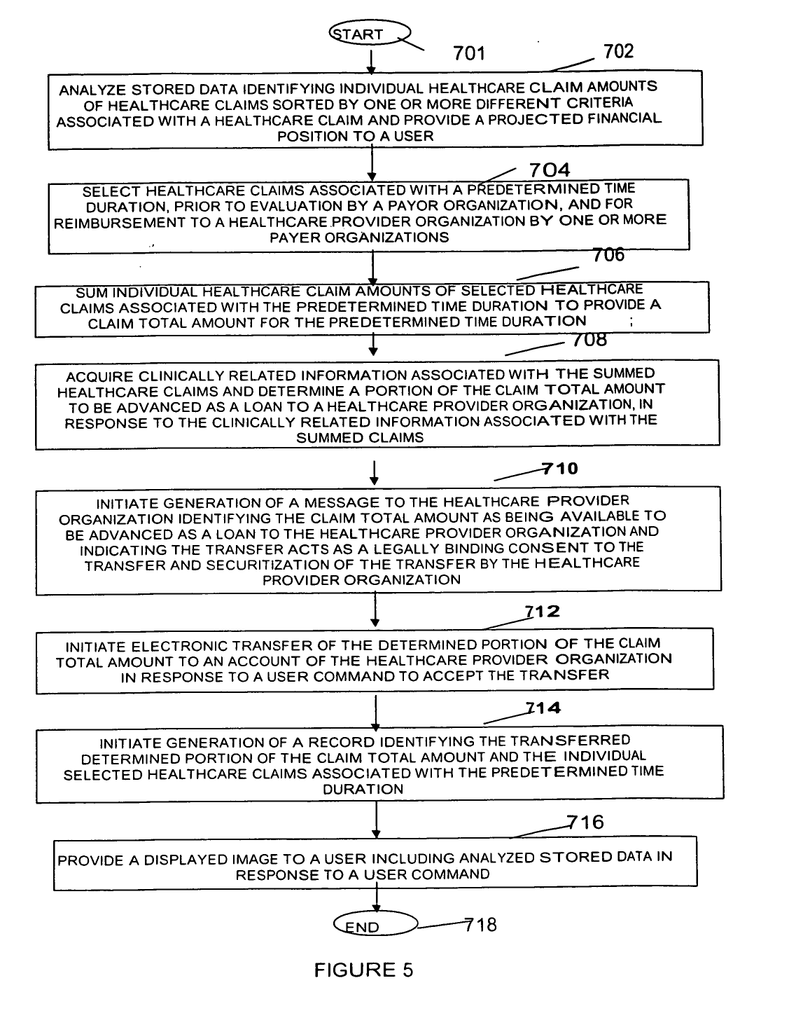

FIG. 5 shows a flowchart of a process employed by loan advance system 25. Loan advance system 25 in step 702, following the start at step 701 analyzes stored data identifying individual healthcare claim amounts of healthcare claims sorted by one or more different criteria associated with a healthcare claim to provide a projected financial position to a user. The different criteria include, a selected time duration, payor organization, health plan, a selected claim minimum amount, a selected claim maximum amount, healthcare provider organization department, healthcare procedure type provided to a patient and a diagnosis, treatment or procedure code associated with a claim. In step 704 loan advance system automatically selects healthcare claims associated with a predetermined time duration, prior to evaluation by a claim payor organization, and for reimbursement to a healthcare provider organization by one or more payor organizations. The selection is done in response to clinically related information associated with a claim of a patient. The clinically related information includes one or more of, a healthcare procedure type, a diagnosis code, a treatment code and a procedure code. Further, system 25 selects healthcare claims by one or more of, provider organization, payor organization, claim type (such as Medicare claims or claims associated with a particular guarantor) and amount.

Loan advance system 25 in step 706 sums individual healthcare claim amounts of selected healthcare claims of multiple patients associated with the predetermined time duration to provide a claim total amount for the predetermined time duration. In step 708 loan advance system 25 acquires clinically related information associated with the summed healthcare claims. The clinically related information includes, a healthcare procedure type, a diagnosis code, a treatment code and a procedure code, for example. System 25 determines a portion of the claim total amount to be advanced as a loan to a healthcare provider organization, in response to the clinically related information associated with the summed claims and prior to evaluation of the claims by a claim payor organization. In step 710 loan advance system 25 initiates generation of a message to the healthcare provider organization identifying the claim total amount as being available to be advanced as a loan to the healthcare provider organization. The message indicates a user command to accept transfer of the loan acts as a legally binding consent to the transfer and securitization of the transfer (with the selected healthcare claims comprising an expectation of payment to the healthcare payor organization) by the healthcare provider organization. In another embodiment the user command to accept the transfer of the loan acts as a legally binding consent to the transfer and securitization of the transfer by other predetermined assets of the healthcare payor organization.

Loan advance system 25 in step 712 initiates electronic transfer of the determined portion of the claim total amount to an account of the healthcare provider organization in response to a user command to accept the transfer. In step 714 system 25 initiates generation of a record identifying the transferred determined portion of the claim total amount and the individual selected healthcare claims associated with the predetermined time duration. In step 716 a user interface of system 25 initiates display of an image to a user including analyzed stored data in response to a user command. In operation, a Hospital financial processing system 48, operating in conjunction with loan advance system 25, generates clean claims in the amount of $100,000 ($100 k) during the period of a day, for example. The generated claims are routed to payer organizations and at the end of business that day, loan advance system 25 deposits $70K in the Hospital intermediary account. The claims continue to be serviced by the Hospital staff and 60 days later the claims are settled by the payer organizations for $80K. Loan advance system 25 collects $2 k ($100k×2%) and the hospital collects $8 k ($80 k settled−$70 k paid−$2 k received by system 25 as a fee).

The integration of cash payment by loan advance system 25 directly with claim generation by financial processing system 48 and clinical information systems (of FIG. 1) supports data capture enabling flexible loan advance strategies (such as in providing loans to a hospital) in an efficient and cost effective manner. The benefit to a customer is increased cash flow. A user can accelerate receipt of cash by two months into the present year, for example. This means up to fourteen months of cash may be acquired in a single year. System 25 advantageously enables loan advances to be made to a healthcare provider organization secured by unadjudicated healthcare claims using a substantial amount of information already available from claims processing and clinical systems of FIG. 1 and minimizing costs of deriving and collating required information. System 25 also supports the preparation of error-free claims, using predictive modeling. Further, monitoring of the claim generation process by loan advance system 25 facilitates submission of correct information to a payer organization, based on historical actual payment history. System 25 allows a healthcare provider organization automated process or billing office to audit a claim prior to submission using payor specific rules. System 25 predicts payment success, predicated on analytical objective historical payment information, calculates an amount to advance and reduces risk of loan default. System 25 also monitors loan reconciliation performance against planned reimbursement and evaluates changes using predictive actuarial payment information. The process shown in the flowchart of FIG. 5 ends at step 718.

The system and processes presented in FIGS. 1-5 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system of FIG. 1 may be implemented in hardware, software or a combination of both.

1. A loan advance system employing healthcare claim information related to provision of healthcare to patients, comprising:
a data acquisition processor for acquiring clinically related information associated with a healthcare claim of a patient and
a loan advance processor for determining a portion of said claim total amount to be advanced as a loan to a healthcare provider organization, in response to said clinically related information associated with said claim and prior to evaluation of said claim by a claim payor organization.

2. A system according to claim 1, wherein
said data acquisition processor acquires clinically related information associated with a plurality of claims of a plurality of patients and
said loan advance processor determines a portion of summed individual healthcare claim amounts of said plurality of claims to be advanced as a loan to a healthcare provider organization.

3. A system according to claim 1, wherein
said plurality of claims of said plurality of patients are associated with a predetermined time duration.

4. A system according to claim 1, wherein
said clinically related information includes at least one of, (a) a healthcare procedure type, (b) a diagnosis code, (c) a treatment code and (d) a procedure code.

5. A system according to claim 1, including
a claim data selector for selecting said healthcare claim in response to clinically related information associated with a claim of a patient.

6. A loan advance system employing healthcare claim information related to provision of healthcare to patients, comprising:
a claim data selector for selecting healthcare claims associated with a predetermined time duration, prior to evaluation by a claim payor organization, and for reimbursement to a healthcare provider organization by one or more payor organizations; and
a data processor for,
summing individual healthcare claim amounts of selected healthcare claims associated with said predetermined time duration to provide a claim total amount for said predetermined time duration and
determining a portion of said claim total amount to be advanced as a loan to said healthcare provider organization.

7. A system according to claim 6, wherein
said claim data selector selects said selected healthcare claims in response to clinically related information associated with a claim of a patient.

8. A system according to claim 7, wherein
said clinically related information includes at least one of, (a) a healthcare procedure type, (b) a diagnosis code, (c) a treatment code and (d) a procedure code.

9. A system according to claim 6, wherein
said data processor determines a portion of said claim total amount to be advanced as a loan to said healthcare provider organization in response to clinically related information associated with a claim of a patient.

10. A system according to claim 6, including
a transaction processor for initiating electronic transfer of said determined portion of said claim total amount to an account of said healthcare provider organization

11. A system according to claim 6, wherein
said claim data selector automatically selects healthcare claims as part of a healthcare claim processing system and
said data processor automatically determines said portion of said claim total amount to be advanced as a loan to said healthcare provider organization.

12. A system according to claim 6, wherein
said data processor initiates generation of a message to said healthcare provider organization identifying said claim total amount as being available to be advanced as a loan to said healthcare provider organization and
said transaction processor initiates electronic transfer of said determined portion of said claim total amount to an account of said healthcare provider organization in response to a user command to accept said transfer.

13. A system according to claim 12, wherein
said user command to accept said transfer acts as a legally binding consent to, said transfer and securitization of said transfer by said individual selected healthcare claims associated with said predetermined time duration.

14. A system according to claim 12, wherein
said user command to accept said transfer acts as a legally binding consent to said transfer and securitization of said transfer by at least one of, (a) healthcare claims comprising an expectation of payment to said healthcare payor organization and (b) other predetermined assets of said healthcare payor organization.

15. A system according to claim 12, wherein
said data processor initiates generation of a message to said healthcare provider organization indicating said user command to accept said transfer acts as a legally binding consent to said transfer and securitization of said transfer by said healthcare provider organization.

16. A system according to claim 6, wherein
a monitoring processor for initiating generation of a record identifying said transferred determined portion of said claim total amount and said individual selected healthcare claims associated with said predetermined time duration.

17. A system according to claim 6, wherein
said claim data selector selects healthcare claims by at least one of, (a) provider organization, (b) payor organization, (c) claim type and (d) amount.

18. A system according to claim 17, wherein
said claim type comprises at least one of, (a) Medicare claims and (b) claims associated with a particular guarantor.

19. A system according to claim 6, including
a data analyzer for analyzing stored data identifying individual healthcare claim amounts of healthcare claims sorted by one or more of a plurality of different criteria associated with a healthcare claim.

20. A system according to claim 19, wherein
said plurality of different criteria include, (a) a selected time duration, (b) payor organization, (c) health plan, (d) a selected claim minimum amount, (e) a selected claim maximum amount, (f) healthcare provider organization department, (g) healthcare procedure type provided to a patient and (h) a diagnosis, treatment or procedure code associated with a claim.

21. A system according to claim 19, wherein
said data analyzer analyzes said stored data identifying individual healthcare claim amounts of healthcare claims to provide a projected financial position to a user.

22. A system according to claim 19, including
a user interface for providing a displayed image to a user including analyzed stored data in response to a user command.

23. A method for use in advancing a loan and employing healthcare claim information related to provision of healthcare to patients, comprising the activities of:
acquiring clinically related information associated with a healthcare claim of a patient and
determining a portion of said claim total amount to be advanced as a loan to a healthcare provider organization, in response to said clinically related information associated with said claim and prior to evaluation of said claim by a claim payor organization.

24. A method for use in advancing a loan and employing healthcare claim information related to provision of healthcare to patients, comprising the activities of:
selecting healthcare claims associated with a predetermined time duration, prior to evaluation by a claim payor organization, and for reimbursement to a healthcare provider organization by one or more payor organizations; and
summing individual healthcare claim amounts of selected healthcare claims associated with said predetermined time duration to provide a claim total amount for said predetermined time duration and
determining a portion of said claim total amount to be advanced as a loan to said healthcare provider organization.
